(19) United States
(12) Patent Application Publication
(10) Pub. No.: US 2024/0184186 A1
(43) Pub. Date: Jun. 6, 2024

(54) GIMBAL ASSEMBLY FOR SUPPORTING A CAMERA

(71) Applicant: VIDENDUM MEDIA SOLUTIONS S.P.A., CASSOLA (VI) (IT)

(72) Inventors: Christopher THOMSON, AUCKLAND (NZ); James ALLEN, AUCKLAND (NZ); Samuel BLOK, AUCKLAND (NZ)

(73) Assignee: VIDENDUM MEDIA SOLUTIONS S.P.A., CASSOLA (VI) (IT)

(21) Appl. No.: 18/284,968

(22) PCT Filed: Apr. 7, 2022
(86) PCT No.: PCT/IB2022/053260

§ 371 Date: Sep. 29, 2023

(30) Foreign Application Priority Data
Apr. 7, 2021 (IT) 102021000008705

(51) Int. Cl. G03B 17/56; F16M 11/12

(52) U.S. Cl. CPC G03B 17/561; F16M 11/123

(57) ABSTRACT

A gimbal assembly for supporting a camera includes a first member, a second member, a third member and a frame. The first member is arranged to support the camera and pivotally supported on the second member so as to rotate about a yaw axis with respect to the second member, the second member is pivotally supported on the third member so as to rotate about a pitch axis with respect to the third member, the pitch axis being orthogonal to the yaw axis, and the third member is pivotally supported on the frame so as to rotate about a roll axis with respect to the frame, the roll axis being orthogonal to the pitch axis and to the yaw axis. The third member is coupled with the frame so that it slides on an internal surface of the frame when the third member rotates about the roll axis.

### TECHNICAL FIELD

The present invention relates to a gimbal assembly for supporting a camera.

### TECHNOLOGICAL BACKGROUND

The present invention is used particularly, though not exclusively, in the technical sector relating to camera stabilization systems, in particular to three-axis gimbal stabilizers.

A three-axis gimbal stabilizer is a structure having a connection for fixing a camera to the structure and movable members connected to each other so as to allow the camera to rotate about a set of three orthogonal axis with respect to a frame so as to obtain a stabilization of images captured by the camera.

An example of a gimbal stabilizer is the product named “AK4000”, developed by Guilin Feiyu Technology Incorporated Company.

However, known gimbal stabilizers may have one or more of the following drawbacks: traditional gimbals are not able to be balanced without a camera and become unstable when the camera is removed; the length of the camera and lens combination is limited by the roll motor and arms; the setup and balancing of the camera is difficult; the forward and backward adjustment of the camera is limited by the roll motor and arms; the gimbal can easily lose the origin point in relation to the handle being held by the user.

### STATEMENT OF INVENTION

The scope of this invention is to provide a gimbal assembly for supporting a camera which is structurally and functionally designed to overcome at least one of the drawbacks of the identified prior art.

This scope is achieved by of a gimbal assembly for supporting a camera obtained according to the independent claim appended to this description.

The preferred characteristics of the invention are defined in the dependent claims.

According to a first aspect of the invention, the gimbal assembly for supporting a camera comprises a first member, a second member a third member and a frame.

The camera is an optical instrument apt to capture images.

The first member is arranged to support the camera.

Moreover, the first member is pivotally supported on the second member so as to rotate about a yaw axis with respect to the second member. The yaw axis is also called pan axis.

Preferably, the first member is arranged to support the camera such that the optical axis of the camera is orthogonal to the yaw axis.

The second member is pivotally supported on the third member so as to rotate about a pitch axis with respect to the third member, the pitch axis being orthogonal to the yaw axis. The pitch axis is also called tilt axis.

Consequently, when second member rotates about the pitch axis, yaw axis rotates about the pitch axis as well.

The third member is pivotally supported on the frame so as to rotate about a roll axis with respect to the frame, the roll axis being orthogonal to the pitch axis and to the yaw axis. The roll axis is also called level axis.

Consequently, when third member rotates about the roll axis, yaw and pitch axes rotates about the roll axis as well.

These features allow the camera to rotate about yaw, pitch and roll axes with respect to the frame.

According to a further aspect of the invention, the third member is coupled with the frame so that the third member slides on an internal surface of the frame when the third member rotates about the roll axis.

This feature allows the gimbal assembly to be more compact since the third member can be arranged totally inside the space delimited by the frame from which the third member does not protrude outward when it rotates about the roll axis.

According to an embodiment of the invention, the frame has a circular shape.

This feature allows the third member to rotate by 360 degrees about the roll axis.

According to an embodiment of the invention, the third member comprises a runner and the internal surface of the frame has a guide profile for the sliding of the runner which lets the third member rotate about the roll axis.

Preferably, the guide profile is a circular groove which extends on the internal surface of the frame.

Preferably, the third member comprises a body, more preferably a circular body, and the runner comprises one or more wheels pivotally supported on the third member's body.

Preferably, the runner is arranged at an external surface of the third member's body.

Preferably, the second member comprises a body, more preferably a ring-shaped body which supports the first member. In particular, the body of the second member is pivotally supported on the body of the third member.

The ring-shaped body of the second member may has an oval or almost oval shape.

Preferably, the second member's body is internal with respect to the body of the third member and it is secured thereto with the ability to rotate with respect to the body of the third member.

According to an embodiment of the invention, the first member comprises a base on which the camera is intended to be fixed.

The base is movable along the yaw axis so as to regulate the position of the camera along the yaw axis.

This feature allows a user to carry out a first regulation of the camera position so as to adjust the balancing of the gimbal assembly in relation to the pitch axis when the camera is supported on the base.

According to an embodiment of the invention, the gimbal assembly comprises a support component slidingly connected to the second member so as to slide along the yaw axis with respect to second member, the support component being operatively connected to the base so that the sliding of the support component causes the base to move along the yaw axis.

Preferably, the support component is a cylindrical-shaped element.

Preferably, the base is pivotally connected to the support component so as to rotate about the yaw axis with respect to the support component.

The gimbal assembly may comprise an actuator which can be operated by an user to slide the support component along the yaw axis.

Preferably, the actuator is a ring connected to the support component by a threaded coupling.

According to an embodiment of the invention, the gimbal assembly comprises a locking device connected to the second member and adapt to lock and unlock the sliding about the yaw axis of the support component with respect to the second member. The locking device may comprise a knob to allow an user to lock and unlock the sliding of the support component.

According to an embodiment of the invention, the base comprises a slider and a linear guide on which the slider can slide. The linear guide longitudinally extends along a direction parallel to the pitch axis.

This feature allows a user to carry out a second regulation of the camera position so as to adjust the balancing of the gimbal assembly in relation to the yaw axis when the camera is supported on the base.

According to an embodiment of the invention, the gimbal assembly comprises a first electric motor attached to the first member and arranged to rotate the first member about the yaw axis relative to the second member, a second electric motor attached to the second member and arranged to rotate the second member about the pitch axis relative to the third member and a third electric motor attached to the third member and arranged to rotate the third member about the roll axis relative to the frame.

The second member comprises electric conductors which are connected to the first, second and third electric motors.

This means that, preferably, the electric conductors are at least partially contained inside the second member, more preferably they are at least partially contained inside the body of the second member.

Preferably, the first, second and third electric motors are energised by the electric conductors. Therefore, the electric components of the gimbal assembly (in particular the electric conductors) are connected to the second member. This arrangement allows the electric components to be integral to the second member so as to avoid subjecting the electric conductors to stretching due to the rotation of the members.

The fact that the second member comprises the electric conductors allows the latter to be installed in the best protected area of the gimbal assembly, for instance for the protection from shocks, in addition to obtain the effect of preventing the electric conductors from being stretched during different rotations of the members.

In particular, the rotation of the first member about a yaw axis and the rotation of the second member about the pitch axis for a maximum angle of rotation lower than 360° does not cause the electric conductors to be twisted.

Preferably, the electric conductors comprise a first conductor, a second conductor and a third conductor which are connected to the first electric motor, the second electric motor and the third electric motor, respectively.

Preferably, the first conductor and the second conductor are entirely contained inside the second member, more preferably they are entirely contained inside the body of the second member.

Preferably, the third conductor is partially contained inside the second member, more preferably it is partially contained inside the body of the second member and extends at least partially inside the third member, in particular inside the body of the third member.

Therefore, in this case, the third conductor extends inside the second member and preferably passes through the rotation axis of the second electric motor, from which the third conductor extends inside the third member.

In particular, the second member comprises a plurality of seats, each seat housing one of the first electric motor, second electric motor and third electric motor.

Each of the first, second and third electric motors comprises a stator and a rotor.

Preferably, the stator of the first electric motor is fixed to the second member, in particular to the body of the second member, whereas its rotor is fixed to the first member, in particular to the base of the first member.

More in particular, the stator of the first electric motor is fixed to the support component of the gimbal assembly whereas the rotor of the first electric motor is fixed to the base of the first member.

In an alternative embodiment, the rotor of the first electric motor is fixed to the second member and its stator is fixed to the first member.

Preferably, the rotor of the second electric motor is fixed to the third member, in particular to the body of the third member, whereas its stator is fixed to the second member, in particular to the body of the second member.

In an alternative embodiment, the stator of the second electric motor is fixed to the third member and its rotor is fixed to the second member.

Preferably, the stator of the third electric motor is fixed to the third member, in particular to the body of the third member, the third member being pivotally attached to the second member, in particular to the body of the second member, by that stator.

Preferably, the rotor of the third electric motor is fixed to a driving wheel, the driving wheel being rotatable in the guide profile of the internal surface of the frame.

According to an embodiment of the invention, the gimbal assembly comprises an energy storage device for suppling electric power to the first, second and third electric motors via the electric conductors, the energy storage device being connected to the electric conductors and attached to the second member.

This feature avoids subjecting the electric conductors to stretching due to the rotation of the members.

According to an embodiment of the invention, the first electric motor is arranged at the yaw axis and the second electric motor is arranged at the pitch axis.

In particular, the first electric motor is arranged such that the rotation axis of its rotor extends along the yaw axis and the second electric motor is arranged such that the rotation axis of its rotor extends along the pitch axis.

According to an embodiment of the invention, the third electric motor and the energy storage device are arranged such that one of the third electric motor and the energy storage device is diametrically opposed to the first electric motor with respect to the pitch axis and the other between the third electric motor and the energy storage device is diametrically opposed to the second electric motor with respect to the yaw axis.

This arrangement allows to obtain a balanced gimbal assembly.

In particular, the third electric motor is arranged such that the rotation axis of its rotor extends along a direction parallel to the roll axis.

Preferably, the energy storage device is diametrically opposed to the first electric motor with respect to the pitch axis.

Preferably, the third electric motor is diametrically opposed to the second electric motor with respect to the yaw axis. Anyway, the third electric motor can be placed anywhere on the third member.

According to an embodiment of the invention, the gimbal has only one first electric motor to rotate the first member about the yaw axis, only one second electric motor to rotate the second member about the pitch axis and only one third electric motor to rotate the third member about the roll axis.

This feature to obtain a light and cost-effective gimbal assembly. In particular, the balanced gimbal assembly obtained by the above-mentioned arrangement of the first, second and third electric motors and the energy storage device makes it possible to use only one first electric motor, only one second electric motor and only one third electric motor.

According to an embodiment of the invention, the first, second and third electric motors are brushless DC electric motors.

The provision of brushless DC electric motors eliminates sliding electric contacts between electric motors and electric conductors to have less friction and longer life of the gimbal assembly.

According to an embodiment of the invention, the gimbal assembly comprises a control unit (preferably a PCBA) operatively connected (preferably by control wires) to the first, second and third electric motors to control the rotation of the first, second and third members so that the camera is oriented towards a target position when the camera is supported by the first member.

The control unit controls the rotation of the first, second and third members by operating the first, second and third electric motors.

Preferably, the first member has a housing which is arranged between the support component and the base of the first member.

In particular, the rotor of the first electric motor is fixed to said base through the housing.

Preferably, the control unit is placed in the housing of the first member.

Preferably, the control wires run through the first electric motor to reach the second and third electric motors.

The control unit may be energised by the energy storage device.

According to an embodiment of the invention, the gimbal assembly comprises a camera sensor device arranged to detect rotations in the space of the first member, in particular of its base, about the yaw axis, pitch axis and roll axis and to generate a signal related to those rotations. This feature allows to detect the orientation of the camera supported on the first member with respect to the frame.

Preferably, the camera sensor device is an inertial measurement unit.

Preferably, the camera sensor device is placed in the housing of the first member.

According to an embodiment of the invention, the camera sensor device is operatively connected (preferably by a control wire) to the control unit.

Preferably, the control unit is configured to control the rotation of the first, second and third members based on the signal generated by the camera sensor device so that the camera is oriented toward the target position when the camera is supported by the first member.

According to an embodiment of the invention, the gimbal assembly comprises a first sensor, a second sensor and a third sensor coupled with the first member, the second member and the third member, respectively, to generate respective signals related to the angle of rotation of these members about their respective axes. In particular, the first, second and third sensors are coupled with the first, second and third electric motors, respectively, to detect rotations of the relevant rotor about its rotational axis and to generate respective signals related to those rotations.

Preferably, the first, second and third sensors are encoders, in particular GMR encoders (i.e. magnetic encoders based on giant magnetoresistance effect).

Preferably, each of first, second and third sensors is on a respective PCBA, which is on the stator side of the relevant electric motor, and is arranged to read a magnet on the end of a shaft of the related rotor.

Preferably, the control unit is operatively connected to the first, second and third sensors, in particular by wires.

Preferably, the control unit is configured to control the rotation of the first, second and third members based on the signal generated by the camera sensor device and on the signals generated by the first, second and third sensors so that the camera is oriented toward the target position when the camera is supported by the first member.

The presence of the first, second and third sensors allows to better control the rotor angular position of the respective electric motors, in particular to accurately control the three motor electrical phases. This aspect allows the camera to be positioned more accurately.

According to an embodiment of the invention, the gimbal assembly comprises at least one leg hinged to the frame, the at least one leg being movable between a first position wherein the at least one leg is adjacent to the frame and a second position wherein the at least one leg extends away from the frame to support the gimbal assembly on a surface.

This feature allows a user to place in a stable manner the gimbal assembly on a surface, in particular on a horizontal surface.

Preferably, the gimbal assembly comprises two legs, more preferably four legs.

According to an embodiment of the invention, the frame has at least one recess which defines a seat for housing the at least one leg when the latter is in the first position.

This feature allows the gimbal assembly to be less voluminous when the at least one leg is in the first position so as to facilitates the transport and/or use thereof.

In particular, the frame has one recess for each leg so that the legs are housed in respective seats of the frame.

According to an embodiment of the invention, the gimbal assembly comprises a spring device connected to the frame and to the at least one leg so as to move the at least one leg from the second position to the first position and to keep the at least one leg in the first position. The spring device may be a torsion spring.

According to an embodiment of the invention, the gimbal assembly comprises a blocking element arranged to lock the at least one leg in the second position when the at least one leg is moved into the second position. The blocking element can be moved between a blocking position, in which the blocking element locks the at least one leg in the second position by mechanical interference between a body of the blocking element and the at least one leg, and a release position in which the blocking element allows the at least one leg to be moved from the second position to the first position, in particular by the spring device if so provided in the gimbal assembly.

Preferably, the blocking element can be operated by an user in in such a way to be moved from the blocking position to the release position. A second spring device can be connected to the frame and to the blocking element so as to move the blocking element from the release position to the blocking position and to keep the blocking element in the blocking position.

According to an embodiment of the invention, the gimbal assembly comprises at least one handle. The frame has at least one connection portion to join in removable way the at least one handle to the frame.

This feature allows a user to easily handle the gimbal assembly.

In particular, the at least one handle is screwed into the at least one connection portion of the frame.

Preferably, the at least one connection portion comprises a flange having an internally threaded central hole. More preferably, the flange is radially indented.

Preferably, the gimbal assembly has two handles.

Preferably, the gimbal assembly has two connection portions arranged at diametrically opposite portions of the frame.

More preferably, the gimbal assembly has three connection portions, wherein two connection portions are arranged at diametrically opposite portions of the frame and the other one is arranged at a portion of the frame which is diametrically opposite to the at least one leg hinged to the frame.

According to an embodiment of the invention, the at least one connection portion is apt to join the at least one handle to the frame in several orientations.

According to an embodiment of the invention, the at least one handle is connected to at least one connection portion of the frame by means of an L-Bracket. Preferably, the handle is connected to the top of the frame by means of an L-Bracket.

According to an embodiment of the invention, the gimbal assembly comprises a controller which is operatively connected to the first, second and third electric motors to control the rotation of the first, second and third members about the relevant axes based on an interaction of an user with the controller.

Preferably, the second member comprises the controller. The controller may be arranged next to the energy storage device.

The controller generates a respective signal based on the interaction of an user therewith.

This feature allows a user to control the orientation of the camera mounted on the gimbal assembly, in particular for moving smoothly the first, second and third members about the relevant axes.

The controller may comprise at least one button and/or at least one wheel and/or at least one switch and/or at least one trigger and/or at least one stick.

Preferably, the controller is connected to the control unit to control the rotation of the first, second and third members.

Therefore, the control unit may control the rotation of the first, second and third members based on the signal generated by the controller so that the camera is oriented towards the target position when the camera is supported by the first member.

Preferably, the controller is connected to the control unit via a wireless communication protocol.

Preferably, the wireless communication is Bluetooth or Wi-Fi protocol.

### BRIEF DESCRIPTION OF THE DRAWINGS

Features and advantages of the invention will be better appreciated from the following detailed description of preferred embodiments thereof which are illustrated by way of non-limiting example with reference to the appended Figures, in which:

FIG. 1 is a schematic front view of a gimbal assembly with a camera according to an embodiment of the invention,

FIG. 2 is a schematic perspective view of the gimbal assembly of FIG. 1, without the camera,

FIGS. 3 and 4 show a cross-section of the gimbal assembly of FIG. 1 and, respectively, 2, which are obtained by a section plane depicted in FIG. 2,

FIG. 5 is a schematic perspective view of a gimbal assembly according to another embodiment of the invention, and

FIG. 6 shows the gimbal assembly of FIG. 5, in which the body 6 has been removed to display some hidden elements in FIG. 5.

### DESCRIPTION OF EMBODIMENTS OF THE INVENTION

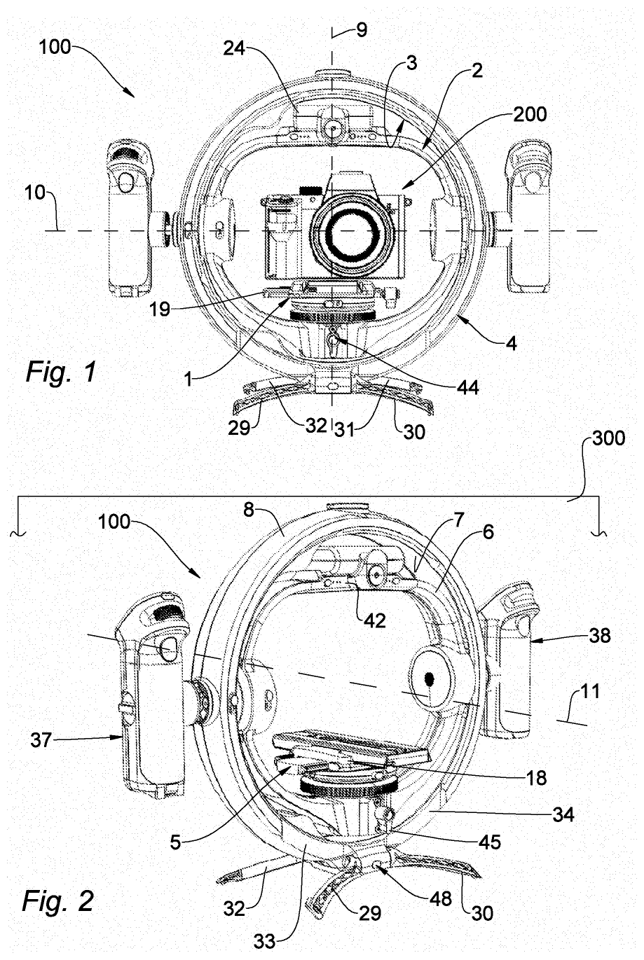

With reference to FIG. 1, a gimbal assembly for supporting a camera 200 according to the present invention is indicated as a whole by the reference number 100.

FIG. 2 shows a perspective view of the gimbal assembly 100 depicted in FIG. 1, without the camera 200.

With reference to FIGS. 1, and 2, the gimbal assembly 100 comprises a first member 1, a second member 2, a third member 3 and a frame 4.

The first member 1 comprises a base 5 on which the camera 200 is fixed, the second member 2 has an ellipse-shape body 6 whereas the third member 3 and the frame 4 have a respective circular body 7,8.

The first member 1 is therefore arranged to support the camera 200 and it is pivotally supported on the body 6 of the second member 2 so as to rotate about a yaw axis 9 with respect to the second member 2.

The second member 2 is pivotally supported on the body 7 of the third member 3 so as to rotate about a pitch axis 10 with respect to the third member 3, the pitch axis 10 being orthogonal to the yaw axis 9.

The third member 3 is pivotally supported on the body 8 of the frame 4 so as to rotate about a roll axis 11 with respect to the frame 4, the roll axis 11 being orthogonal to the pitch axis 10 and to the yaw axis 9.

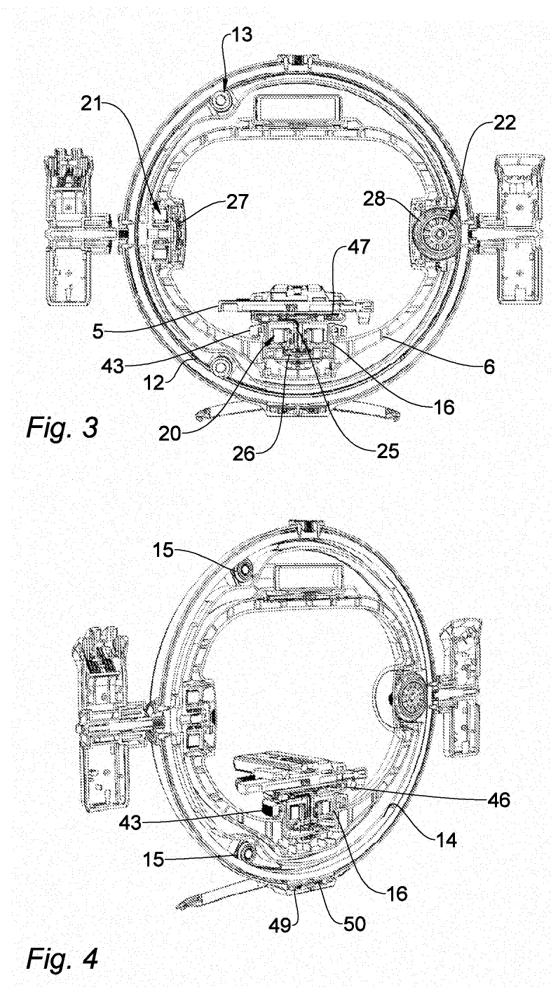

FIG. 3 shows a cross-section of the gimbal assembly 100 cut by a section plane 300 depicted in FIG. 2.

With reference to FIG. 3, the third member 3 is coupled with the frame 4 so that the third member 3 slides on an internal surface 12 of the frame 4 when the third member 3 rotates about the roll axis 11. In detail, the third member 3 comprises a runner 13 and the internal surface 12 of the frame 4 has a guide profile 14 for the sliding of the runner 13.

The guide profile 14 is a circular groove which extends on the internal surface 12 of the frame 4 and the runner 13 comprises a plurality of wheels 15 pivotally supported on the body 7.

The gimbal assembly 100 comprises a cylindrical-shaped element 16 connected to the body 6 of the second member 2 by a sliding coupling so that the cylindrical-shaped element 16 can move up and down along the yaw axis 9 with respect to second member 2. The cylindrical-shaped element 16 is connected to the base 5 so that the sliding of the cylindrical-shaped element 16 causes the base 5 to move along the yaw axis 9.

The gimbal assembly 100 comprises a ring 43 connected to the cylindrical-shaped element 16 by a threaded coupling and the ring 43 can be operated by an user to slide the cylindrical-shaped element 16 along the yaw axis 9.

A locking device 44 is connected to the body 6 of the second member 2. The locking device 44 is adapt to lock and unlock the sliding about the yaw axis of the cylindrical-shaped element 16 with respect to the second member 2. The locking device 44 comprises a knob 45 to allow the user to lock and unlock the sliding of the cylindrical-shaped element 16.

Moreover, the base 5 comprises a slider 18 and a linear guide 19 on which the slider 18 can slide. The linear guide 19 longitudinally extends along a direction parallel to the pitch axis 10. These features allow to regulate the position of the camera 200 relative to the second member 2.

FIG. 4 shows an additional view of the cross-section of the gimbal assembly 100.

With reference to FIGS. 3 and 4, the gimbal assembly 100 comprises a first electric motor 20 attached to the first member 1 and arranged to rotate the first member 1 about the yaw axis 9 relative to the second member 2, a second electric motor 21 attached to the second member 2 and arranged to rotate the second member 2 about the pitch axis 10 relative to the third member 3 and a third electric motor 22 attached to the third member 2 and arranged to rotate the third member 3 about the roll axis 11 relative to the frame 4. The second member 2 comprises electric conductors 23 (which are shown in FIG. 6) which are connected to the first, second and third electric motors 20,21,22.

In detail, the first, second and third electric motors 20,21,22 are brushless DC electric motors. Moreover, the gimbal assembly 100 comprises an energy storage device 24 for suppling electric power to the first, second and third electric motors 20,21,22 via the electric conductors 23, the energy storage device 24 being connected to the electric conductors 23 and attached to the second member 2.

The first electric motor 20 is arranged such that the rotation axis of its rotor extends along the yaw axis 9, the second electric motor 21 is arranged such that the rotation axis of its rotor extends along the pitch axis 10 and the third electric motor 22 is arranged such that the rotation axis of its rotor extends along a direction parallel to the roll axis 11.

In detail, the third electric motor 22 is diametrically opposed to the second electric motor 21 with respect to the yaw axis 9 whereas the energy storage device 24 is diametrically opposed to the first electric motor 1 with respect to the pitch axis 10.

As shown in the Figures, the gimbal assembly 100 has only three electric motors: the first electric motor 20, the second electric motor 21 and the third electric motor 22.

In addition, the gimbal assembly 100 comprises a control unit 25 fixed to the first member and operatively connected to the first, second and third electric motors 20,21,22 to control the rotation of the first, second, and third members 1,2,3 so that the camera 200 is oriented towards a target position.

The control unit 25 is placed in a housing 46 of the first member 1, the housing 46 being arranged between the cylindrical-shaped element 16 and the base 5.

Moreover, the gimbal assembly 100 comprises a camera sensor device 47 arranged to detect rotations of the base 5 in the space about the yaw axis, pitch axis and roll axis and to generate a signal related to those rotations.

The camera sensor device 47 is connected to the control unit 25 so that the control unit 25 controls the rotation of the first, second and third members based on the signal generated by the camera sensor device 47 for positioning the camera toward the target position.

The gimbal assembly 100 also comprises a first sensor 26, a second sensor 27 and a third sensor 28 coupled with the first member 1, the second member 2 and the third member 3, respectively, to generate respective signals related to the angle of rotation of these members about their respective axes. These sensors 26,27,28 are operatively connected to the control unit 25.

With reference to Figures, the gimbal assembly 100 comprises four legs 29,30,31,32 hinged to the frame 4, the legs 29,30,31,32 being movable between a first position wherein the legs are adjacent to the frame 4 and a second position wherein the legs extend away from the frame 4 to support the gimbal assembly 100 on a horizontal surface. The frame 4 has four recesses 33,34,35,36 which define respective seats for housing respective legs 29,30,31,32 when the latter are in the first position.

In particular, FIGS. 1 and 2 show the gimbal assembly 100 having the legs 29,30,31,32 in the second position.

The gimbal assembly 100 comprises a blocking element 48 arranged to lock the legs 29,30,31,32 in the second position when the legs are moved into the second position. The blocking element 48 can be moved between a blocking position, in which the blocking element 48 locks the legs 29,30,31,32 in the second position by mechanical interference between a body 49 of the blocking element 48 and the legs, and a release position in which the blocking element 48 allows the legs 29,30,31,32 to be moved from the second position to the first position by a spring device 50. The spring device 50 is connected to the frame 4 and to the legs so as to move the legs 29,30,31,32 from the second position to the first position and to keep the legs in the first position.

The blocking element 48 can be operated by an user in in such a way to be moved from the blocking position to the release position. A second spring device is connected to the frame 4 and to the blocking element 48 so as to move the blocking element 48 from the release position to the blocking position and to keep the blocking element in the blocking position.

With reference to figures, the gimbal assembly 100 comprises two handles 37,38 and the frame 4 has three connection portions 39,40,41 to join in removable way the handles 37,38 to the frame 4. The connection portions 39,40,41 are apt to join the handles 37,38 to the frame 4 in several orientations.

Each of connection portions 39,40,41 comprises a flange 51 having an internally threaded central hole which allows a handle to be screwed into the connection portion.

The flange is radially indented.

In detail, two connection portions 39,40 are arranged at diametrically opposite portions of the frame 4 and the other one is arranged at a portion of the frame 4 which is diametrically opposite to the legs 29,30,31,32.

The gimbal assembly 100 has a controller 42 next to the energy storage device 24. The controller 42 is operatively connected to the first, second and third electric motors 20,21,22 to control the rotation of the first, second and third members 1,2,3 about the relevant axes based on an interaction of an user with the controller 42. The controller 42 generate a signal based on the interaction of an user therewith.

In detail, the controller 42 is connected to the control unit 25 by a Bluetooth or Wi-Fi communication to control the rotation of the first, second and third members 1,2,3.

Consequently, the control unit 25 controls the rotation of the first, second and third members 1,2,3 so that the camera 200 is oriented towards the target position based on the signals generated by camera sensor device 47 and the signal generated by the controller 42.

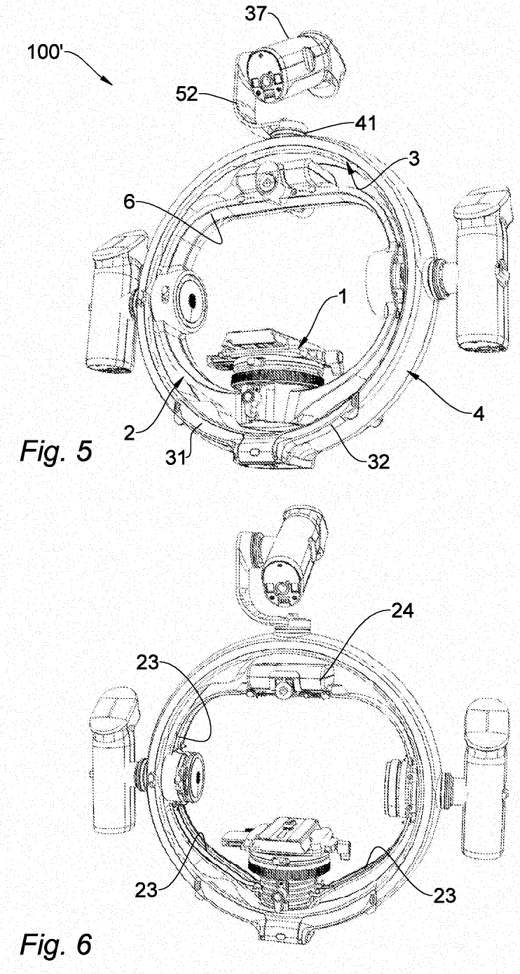

FIG. 5 shows a second embodiment of the gimbal assembly, indicated by the reference number 100′.

The gimbal assembly 100′, in addition to having the features described above concerning the first embodiment of the gimbal assembly, comprises a further handle 37 connected to the top of the frame 4 by means of an L-Bracket 52. Alternatively, the gimbal assembly 100′ may have only the handle 37 on the top of the frame 4, i.e. it is devoid of further handles on the sides of the frame 4.

Moreover, FIG. 5 shows the gimbal assembly 100′ having the legs 29,30,31,32 in the first position.

FIG. 6 shows the gimbal assembly of FIG. 5, in which the body 6 has been removed to display the electric conductors 23 which are connected to the first, second and third electric motors 20,21,22.

The invention thereby solves the problem set out, at the same time achieving a number of advantages.

1. Gimbal assembly (100;100′) for supporting a camera (200), comprising a first member (1), a second member (2), a third member (3) and a frame (4), wherein the first member (1) is arranged to support the camera (200) and pivotally supported on the second member (2) so as to rotate about a yaw axis (9) with respect to the second member (2), the second member (2) is pivotally supported on the third member (3) so as to rotate about a pitch axis (10) with respect to the third member (3), the pitch axis (10) being orthogonal to the yaw axis (9), and the third member (3) is pivotally supported on the frame (4) so as to rotate about a roll axis (11) with respect to the frame, (4) the roll axis (11) being orthogonal to the pitch axis (10) and to the yaw axis (9), and wherein the third member (3) is coupled with the frame (4) so that the third member (3) slides on an internal surface (12) of the frame (4) when the third member (3) rotates about the roll axis (11).

2. The gimbal assembly according to claim 1, wherein the third member (3) comprises a runner (13) and the internal surface (12) of the frame (4) has a guide profile (14) for the sliding of the runner (13) which lets the third member (3) rotate about the roll axis (11).

3. The gimbal assembly according to claim 1, wherein the frame (4) has a circular shape.

4. The gimbal assembly according to claim 1, wherein the first member (1) comprises a base (5) on which the camera (200) is intended to be fixed, the base (5) being movable along the yaw axis (9) so as to regulate positioning of the camera (200) along the yaw axis (9).

5. The gimbal assembly according to claim 4, further comprising a support component (16) slidingly connected to the second member (2) so as to slide along the yaw axis (9) with respect to second member (2), the support component (16) being operatively connected to the base (5) so that the sliding of the support component (16) causes the base (5) to move along the yaw axis (9).

6. The gimbal assembly according to claim 1, further comprising a first electric motor (20) attached to the first member (2) and arranged to rotate the first member (1) about the yaw axis (9) relative to the second member (2), a second electric motor (21) attached to the second member (2) and arranged to rotate the second member (2) about the pitch axis (10) relative to the third member (3) and a third electric motor (22) attached to the third member (3) and arranged to rotate the third member (3) about the roll axis (11) relative to the frame (4), wherein the second member (2) comprises electric conductors (23) which are connected to the first, second and third electric motors.

7. The gimbal assembly according to claim 6, further comprising an energy storage device (24) for suppling electric power to the first, second and third electric motors (20,21,22) via the electric conductors (23), the energy storage device (24) being connected to the electric conductors (23) and attached to the second member (2).

8. The gimbal assembly according to claim 6, wherein the first electric motor (20) is arranged at the yaw axis (9) and the second electric motor (21) is arranged at the pitch axis (10).

9. The gimbal assembly according to claim 7, wherein the third electric motor (22) and the energy storage device (24) are arranged such that one of the third electric motor (22) or the energy storage device (24) is diametrically opposed to the first electric motor (20) with respect to the pitch axis (10) and the other between the third electric motor (22) or the energy storage device (24) is diametrically opposed to the second electric motor (21) with respect to the yaw axis (9).

10. The gimbal assembly according to any claim 6, wherein the gimbal assembly (100) has only one first electric motor (20) to rotate the first member (1) about the yaw axis (9), only one second electric motor (21) to rotate the second member (2) about the pitch axis (10) and only one third electric motor (22) to rotate the third member (3) about the roll axis (11).

11. The gimbal assembly according to claim 6, wherein the first, second and third electric motors (20,22,22) are brushless DC electric motors.

12. The gimbal assembly according to claim 6, further comprising a control unit (25) operatively connected to the first, second and third electric motors (20,21,22) to control the rotation of the first, second and third members (1,2,3) so that the camera is oriented towards a target position when the camera is supported by the first member (1).

13. The gimbal assembly according to claim 12, further comprising a camera sensor device (47) arranged to detect rotations in the space of the first member (1) about yaw axis (9), pitch axis (10) and roll axis (11) and to generate a signal related to said rotations, the camera sensor device (47) being operatively connected to the control unit (25) and the control unit (25) being configured to control the rotation of the first, second and third members (1,2,3) based on the signal generated by the camera sensor device (47) so that the camera is oriented toward the target position when the camera is supported by the first member (1).

14. The gimbal assembly according to claim 13, further comprising a first sensor (26), a second sensor (27) and a third sensor (28) coupled with the first member (1), the second member (2) and the third member (3), respectively, to generate respective signals related to an angle of rotation of said members about their respective axes, the first, second and third sensors (26,27,28) being operatively connected to the control unit (25) and the control unit (25) being configured to control rotation of the first, second and third members (1,2,3) based on the signal generated by the camera sensor device (47) and on the signals generated by the first, second and third sensors (26,27,28) so that the camera (200) is oriented toward the target position when the camera (200) is supported by the first member (1).

15. The gimbal assembly according to claim 6, further comprising a controller (42) which is operatively connected to the first, second and third electric motors (20,21,22) to control the rotation of the first, second and third members (1,2,3) about relevant axes based on an interaction of a user with the controller (42).

16. The gimbal assembly according to claim 1, further comprising at least one leg (29,30,31,32) hinged to the frame (4), the at least one leg (29,30,31,32) being movable between a first position wherein the at least one leg (29,30,31,32) is adjacent to the frame (4) and a second position wherein the at least one leg (29,30,31,32) extends away from the frame (4) to support the gimbal assembly (100) on a surface.

17. The gimbal assembly according to claim 16, wherein the frame (4) has at least one recess (33,34,35,36) which defines a seat for housing the at least one leg (29,30,31,32) when the at least one leg is in the first position.

18. The gimbal assembly according to claim 16, further comprising a blocking element (48) arranged to lock the at least one leg (29,30,31,32) in the second position when the at least one leg (29,30,31,32) is moved into the second position, the blocking element (48) being movable between a blocking position, in which the blocking element (48) locks the at least one leg (29,30,31,32) in the second position by mechanical interference between a body (49) of the blocking element (48) and the at least one leg (29,30,31,32), and a release position in which the blocking element (48) allows the at least one leg (29,30,31,32) to be moved from the second position to the first position, by a spring device (50).

19. The gimbal assembly according to claim 1, further comprising at least one handle (37,38) wherein the frame (4) has at least one connection portion (39,40,41) to join in removable way the at least one handle (37,38) to the frame (4).

20. The gimbal assembly according to claim 19, wherein the at least one connection portion (39,40,41) is configured to join the at least one handle (37,38) to the frame (4) in several orientations.
